(19) United States
(12) Patent Application Publication
(10) Pub. No.: US 2004/0151182 A1
(43) Pub. Date: Aug. 5, 2004

(54) Communication device and communication method

(76) Inventors: Takashi Kokubo, Ome-shi (JP); Takehiko Okuyama, Yokohama-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/700,622

(22) Filed: Nov. 5, 2003

(30) Foreign Application Priority Data
Nov. 5, 2002 (JP) 2002-321355

(51) Int. Cl. H04L 12/56

(52) U.S. Cl. 370/395.1; 370/470; 370/472

(57) ABSTRACT

A communication device has a padding unit which adds data to an asynchronous packet to form an integer multiple of the block length, an encryption unit which encrypts the added asynchronous packet and a synchronous packet, and a transmitting unit which transmits the encrypted padded asynchronous packet and the encrypted synchronous packet.

### CROSS-REFERENCE TO RELATED APPLICATIONS

This application is based upon and claim the benefit of priority from the prior Japanese Patent Application No. 2002-321355, filed Nov. 5, 2002, the entire contents of which are incorporated herein by reference.

### BACKGROUND OF THE INVENTION

1. Field of the Invention

The present invention relates to a communication device for conducting packet communication, or in particular to a communication device and a communication method for conducting the packet communication by encrypting asynchronous packets.

2. Description of the Related Art

With the recent development and extension of the use of a great variety of digital devices, demand has arisen for the functions of communication between digital devices. As a specific example, a DTV (Digital Television) and a DVD (Digital Versatile Disk) player having the communication functions such as IEEE (Institute of Electrical Electronics Engineers) 1394 have come to be widely used.

An example of the conventional techniques (as described in Jpn. Pat. Appln. KOKAI Publication No. 08-184881) related to these devices is a digital device having the function of copying the digital information to be handled. This conventional digital device, for example, comprises a transmitting-side interface including means for detecting the copy generation management information from a predetermined data format and means for converting the predetermined data format into a packet format of a network bus, wherein the detected copy management information is inserted at a predetermined position of the packet format after conversion by the conversion means and sent out to the network bus. The digital device, though not expressly described, is considered applicable to the synchronous packet under IEEE1394.

Nevertheless, a method of encrypting an asynchronous packet is not described. In the case where synchronous packets are encrypted by the DTCP (Digital Transmission Content Protection) encryption scheme or the like, therefore, the information of asynchronous packets (image information, etc.) cannot be encrypted together with the synchronous packets and therefore no security can be maintained.

Specifically, in the conventional communication devices, the encryption process such as the block cipher used for synchronous packets cannot be used directly for asynchronous packets due to different data length. In a digital device which handles synchronous packets coexisting with asynchronous packets, therefore, only the synchronous packets are encrypted with block cipher while asynchronous packets are not encrypted for communication, thereby posing the problem that the asynchronous packets are exposed to illegal copying by a third party and security cannot be maintained.

### BRIEF SUMMARY OF THE INVENTION

According to an embodiment of the invention, there is provided a communication device comprises a padding unit which adds data to an asynchronous packet to form an integer multiple of a block length; an encryption unit which encrypts the asynchronous packet added by the padding unit and a synchronous packet; and a transmitting unit which transmits the added asynchronous packet and the synchronous packet encrypted by the encryption unit.

### BRIEF DESCRIPTION OF THE SEVERAL VIEWS OF THE DRAWING

FIG. 1 is a block diagram showing an example of a configuration of a TV set making up a communication system according to the invention;

FIG. 2 is a diagram for explaining the padding process executed on asynchronous packets in a communication device according to the invention;

FIG. 3 is a diagram for explaining that control information is added to asynchronous packets padded in a communication device according to the invention;

FIG. 4 is a diagram for explaining that an exclusive asynchronous packet for the control information is added to the asynchronous packet padded in a communication according to the invention;

FIG. 5 is a flowchart for explaining the operation of transmitting by padding an asynchronous packet in a communication device according to the invention;

FIG. 6 is a flowchart for explaining the operation of receiving an asynchronous packet padded in a communication device according to the invention; and

FIG. 7 is a system diagram showing an example of a network system configured of a communication device according to the invention.

### DETAILED DESCRIPTION OF THE INVENTION

A communication device according to an embodiment of the invention will be explained in detail below with reference to the accompanying drawings.

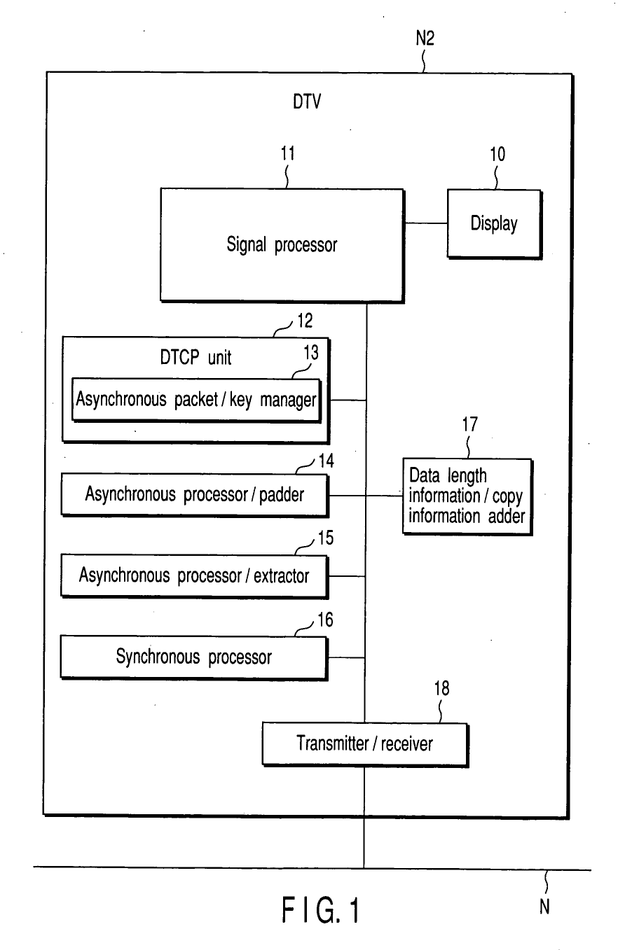

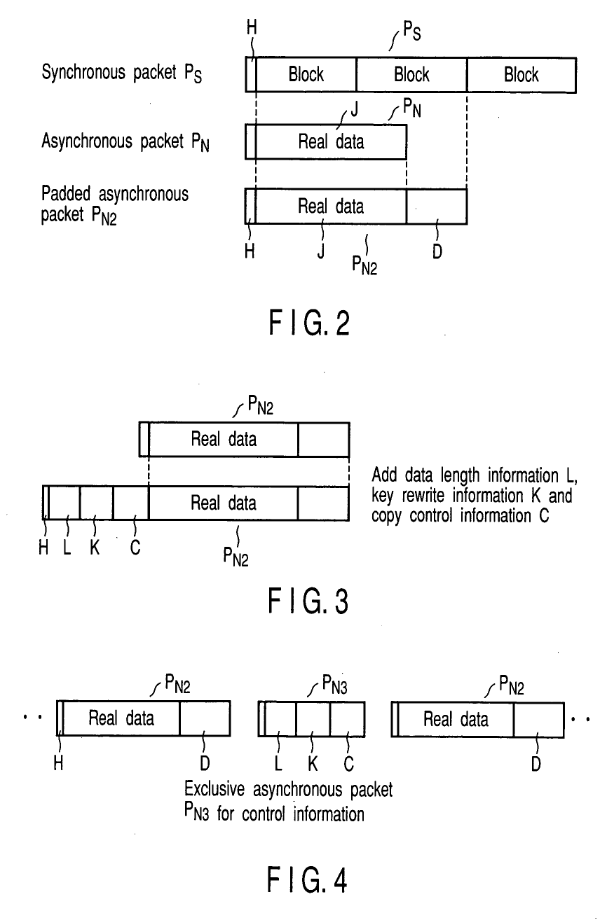

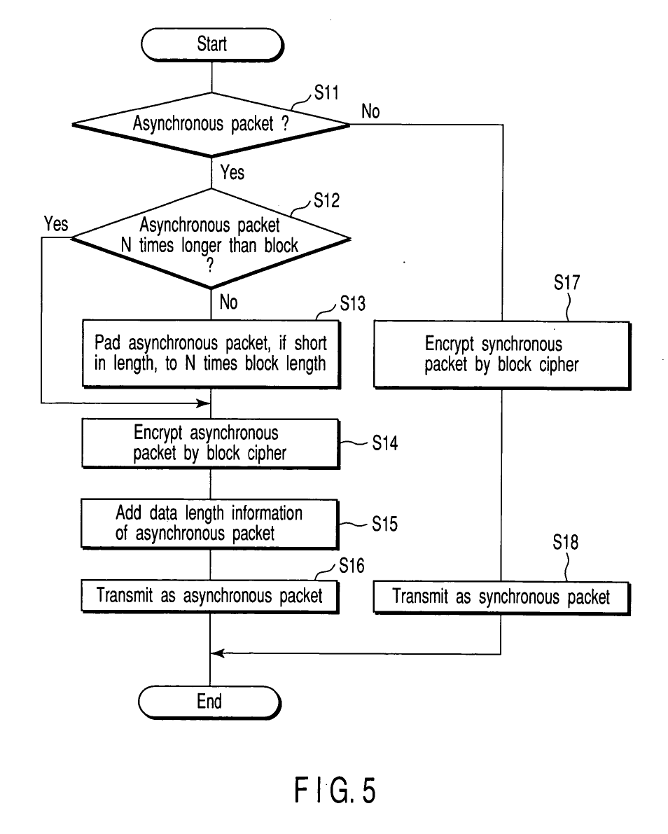

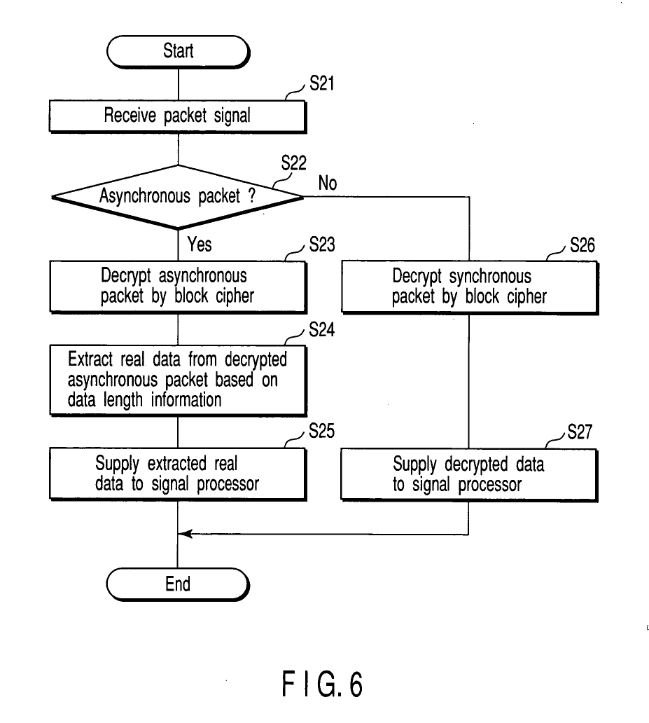

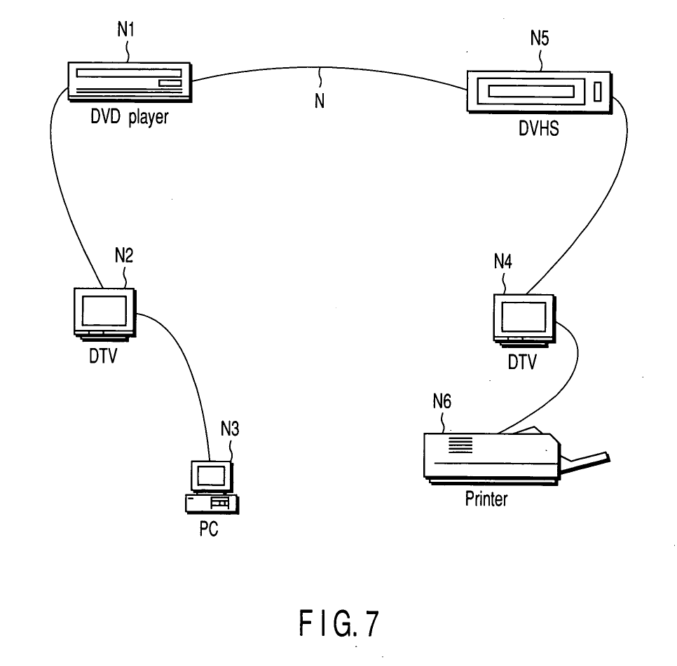

FIG. 1 is a block diagram showing an example of a configuration of a TV set making up a communication device according to the invention, FIG. 2 is a diagram for explaining the padding process executed on an asynchronous packet in a communication device according to the invention, FIG. 3 is a diagram for explaining that control information is added to the padded asynchronous packet padded, FIG. 4 is a diagram for explaining that an exclusive asynchronous packet for the control information is added to the padded asynchronous packet, FIG. 5 is a flowchart for explaining the operation of transmitting by padding an asynchronous packet, FIG. 6 is a flowchart for explaining the operation of receiving the asynchronous packet padded, and FIG. 7 is a system diagram showing an example of a network system configured of a communication device according to the invention.

Here, above description, “the padding process” can be expressed similarly that it is equal to “the padding process which adds data to an asynchronous packet (P_{N}) to form an integer multiple of a block length. That is to say, in this specification, the term “pad” can be changed to the term “add”.

[Configuration of Communication Device and Network System]

A communication device according to the invention is a digital device such as a digital TV, which has the communication functions of IEEE1394 or the like. The information transferred through these devices are handled in packets which are divided into synchronous packets and asynchronous packets.

In FIG. 1, a communication device N2 comprises a signal processor 11 having the original functions of digital TV including a tuning circuit, a decoding circuit, a video processing circuit and an audio amplifier, and a display unit 10 for displaying images. Further, the communication device N2 comprises communication functions such as a DTCP unit 12 for executing the block encryption process and an asynchronous packet/key management unit 13 included in the DTCP unit 12. The communication device N2 further comprises an asynchronous processor/padding processor 14 connected to the signal processor 11 and the DTCP unit 12 through a data bus for handling the asynchronous packets to be transmitted, an asynchronous processor/extractor 15 for handling the received asynchronous packets, a synchronous processor 16 for handling synchronous packets, a data length information/copy information adder 17 for adding the data length information and copy information to the packets, and a transmitter/receiver 18.

Furthermore, the communication device according to the invention makes up a network N connected to a plurality of digital devices. This network is shown in the system diagram of FIG. 7. Specifically, in FIG. 7, the communication device according to the invention is used with a network system configured of a DVD player N1, a DTVN 2, a PC (Personal Computer) N3, a DTVN 4, a DVHSN 5 and a printer N6 connected to the network N in FIG. 7.

In this embodiment, the packet communication based on IEEE1394 as a communication protocol is shown. The invention is, however, not limited to this communication protocol, but may use protocols for other network communications.

[Communication Operation and Padding Operation According to the Invention]

Next, the communication operation of a communication device according to the invention and the padding operation unique to the invention will be explained in detail with reference to a timing chart and a flowchart for the packets.

First, the difference between synchronous packets and asynchronous packets will be explained. Synchronous packets are used mainly for dynamic image data and voice data, and has temporal limitation for packet transmission. Also, the time can be set between the transmitting and receiving ends. The synchronous packets are used for real time transmission, and the length of the real data portion of the packet is an integer multiple of a fixed value. Asynchronous packets, on the other hand, are used mainly for control data and still image data, and have no temporal limitation. Being used for non-real time transmission, the asynchronous packets can be modulated.

The display unit 10 and the signal processor 11 of the DTV (Digital Television) N2 shown in FIG. 1 have the original configuration of digital TV. A broadcast signal from an external source is received and demodulated to output a video signal. A corresponding image is displayed on the display unit 10.

Further, this video signal is transmitted as synchronous packets to the DVHSN 5 shown in FIG. 7 according to the communication protocol of IEEE1394, for example, using the associated communication functions. A still image signal constituting a part of the video signal, on the other hand, is transmitted as asynchronous packets to the printer N6 shown in FIG. 7. With reference to a flowchart, the transmitting operation and the receiving operation will be explained in detail below.

[Transmitting Operation]

First, in the flowchart of FIG. 5, it is determined whether the packet communication is conducted using synchronous or asynchronous packets (S11). In the case where synchronous packets are used for the packet communication, as shown in FIG. 2, each synchronous packet PS of a length equal to an integer multiple of a predetermined block length supplied from the signal processor 11 is supplied to the DTCP unit 12 and encrypted in blocks (S17). After being processed in a synchronous processor 16, the synchronous packet PS is supplied to other communication devices such as the DVHSN 5 on the network N through the transmitting unit 18 (S18).

In the case where the packet communication is carried out with asynchronous packets (S11), on the other hand, as shown in FIG. 2, it is determined whether the real data J of the asynchronous packets has a length equal to an integer multiple of the block length or not (S12). The asynchronous packets, if as long as an integer multiple of the block length, are supplied directly to the DTCP unit 12 without being padded, and encrypted in blocks (S14). The asynchronous packets, if not equal in length to an integer multiple of the block length, are subjected to the padding process by the padding unit 14. Specifically, as shown in FIG. 2, the asynchronous packets PN are subjected to the padding process in which the additional data D is added to the real data J. The asynchronous packets are thus adjusted in a length to an integer multiple (or double) of the block length in preparation for the subsequent block encryption in the DTCP unit 12 (S13). The asynchronous packet PN2 thus padded is supplied to the DTCP unit 12 and encrypted in blocks (S14).

After that, the asynchronous packet P_{N2} that has been encrypted in a similar way to a synchronous packet, as shown in FIG. 3, has the data length information of the real data J added after the header H, for example, by the data length information adder 17 (S15). Then, the packet P_{N2} is transmitted to the transmitter 18, and through the network N to the printer N6, for example (S16).

By doing so, the communication device according to the invention can carry out the communication process while at the same time maintaining security, by encrypting, with block cipher or the like, the information in the asynchronous packets in a manner similar to the information in the synchronous packets.

Further, as shown in FIG. 3, the encryption key for encryption in the DTCP unit 12 is not directly used for the asynchronous packets, but the encryption key is rewritten by the key management unit 13 based on the key rewrite information K, for example, in accordance with the time. This key rewrite information K is suitably added after the header H, as shown in FIG. 3. In this way, the asynchronous packets, like the synchronous packets, can be encrypted using a time-varying key. Thus, the asynchronous packets can be encrypted/decrypted by the same technique as the synchronous packets.

The key rewrite information K may take various forms. For example, it may be time information indicating when the time-varying key has changed, or a flag indicating that the time-varying key has changed, or encryption information for rewriting the key. The key rewrite information K is preferably shared by the synchronous and asynchronous packets.

Further, the copy control information C indicating that the number of times the packet information is copied is limited to one or zero is also preferably added after the header H of the asynchronous packet P_{N2}. This copy control information specifies the number of times the copying is permitted, by the 2-bit information, for example. As a result, the copyright of the contents of the asynchronous packets, like that of the synchronous packets, can be protected to a predetermined degree by the same method as in the synchronous packets by limiting the number of times the contents are copied.

Furthermore, as shown in FIG. 4, the control information including the data length information L, the key rewrite information K and the copy control information C are added not necessarily after the header H as shown in FIG. 3. Instead, an exclusive packet P_{N3} for the control information is prepared by the functions of the data length information/copy control information adder 17, for example, and inserted suitably between the asynchronous packets P_{N2}. In this way, the encryption/decryption process and the copying. process can be controlled using a time-varying key for the asynchronous packets, like the synchronous packets.

[Receiving Operation]

The synchronous packets and the asynchronous packets transmitted by the operation described above are received by other communication devices through the network N, and the receiving operation is performed as described below.

Specifically, in the flowchart of FIG. 6, upon receipt of a communication packet by the receiver 18 (S21), it is determined whether the communication packet is a synchronous packet or an asynchronous packet (S22). In the case where the communication packet is a synchronous packet PS, the sync processor 16 executes such process as extracting the control information from the header H or the like, and then supplies the packet to the DTCP unit 12, where it is decrypted based on the encryption key by block cipher. In the case where the time-varying key is used for the encryption process, the encryption key is rewritten to the one used for encryption by use of the key rewrite information K extracted from the header H or the like, after which the synchronous packet is decrypted using the rewritten encryption key (S26). The synchronous packet thus decrypted is supplied to the signal processor 11 (S27).

In the case where it is determined that the communication packet is an asynchronous packet (S22), on the other hand, the asynchronous packet P_{N2} is supplied to the DTCP unit 12 and decrypted by block cipher (S23). In the case where the time-varying key is used for encryption, the encryption key is rewritten to the one used for encryption by the key rewrite information K added after the header H by the key management unit 13, after which the asynchronous packet P_{N2} is decrypted using the rewritten encryption key.

After that, the asynchronous packet P_{N2} is supplied to the asynchronous processor/extractor 15, and based on the data length information L added after the header H, as shown in FIG. 2, the real data J excluding the added data D is extracted (S24). After that, the extracted real data J is supplied to the signal processor 11 (S25).

By doing so, in the communication device according to the invention, the information for the asynchronous packets, like those for the synchronous packets, can be decrypted by block cipher or the like. Thus, the communication process can be executed while maintaining security.

Further, assume that the copy control information C indicating that the number of times the packet information is copied is limited to, say, one or zero, or that the packet information can be copied any number of time without limitation is added after the header H of the asynchronous packet P_{N2}. Then, the signal processor 11 performs the copy control operation on the real data J making up the contents of the asynchronous packet P_{N2}, based no the copy control information C. As a result, for the asynchronous packets, like the synchronous packets, the copyright of the contents can be protected to a predetermined degree in the same manner as the synchronous packets by limiting the number of times the contents are copied.

Furthermore, as shown in FIG. 4, the control information including the data length information L, the key rewrite information K and the copy control information C can be transmitted as an exclusive packets P_{N3} for the control information inserted between the asynchronous packets P_{N2}. In the asynchronous processor/extractor 15, each control information is recovered from the exclusive packet P_{N3} and used for the subsequent control operations. As a result, the asynchronous packets, like the synchronous packets, can be encrypted/decrypted and the copy operation thereof controlled by a similar technique using the time-varying key.

By the various embodiments described above, those skilled in the art can implement this invention. Further, those skilled in the art can conceive various modifications of these embodiments easily, and apply the invention to various embodiments without specific inventive ability. This invention, therefore, covers a wide range not in contradiction with the principle and the novel features disclosed above and is not limited to the embodiments described above.

It will thus be understood from the foregoing detailed description that according to this invention, even asynchronous packets of a length not an integer multiple of the encryption block length can be encrypted and decrypted similarly to synchronous packets by adjusting the data length through the padding process. As a result, there is provided a communication device which can execute the communication process while maintaining security for asynchronous packets similarly to synchronous packets.

What is claimed is:

1. A communication device comprising:
a padding unit which adds data to an asynchronous packet to form an integer multiple of a block length;
an encryption unit which encrypts the asynchronous packet added by the padding unit and a synchronous packet; and
a transmitting unit which transmits the added asynchronous packet and the synchronous packet encrypted by the encryption unit.

2. A communication device according to claim 1, further comprising:
a data length information adder which adds data length information on the length of the real data of the asynchronous packet to the encrypted added asynchronous packet.

3. A communication device according to claim 1, further comprising:
a key management unit which rewrites the key information used for encryption by the encryption unit, based on key rewrite information, and adds the key rewrite information to the encrypted added asynchronous packet.

4. A communication device according to claim 1, further comprising:
a copy control information adder which adds copy control information which limits the number of times the asynchronous packet is copied, to the encrypted added asynchronous packet.

5. A communication device according to claim 1, further comprising:
an adder which inserts, between the encrypted added asynchronous packets, selected one of control information including data length information on a length of real data of the asynchronous packet, key rewrite information which rewrites key information used for encryption by the encryption unit and copy control. information for limiting the number of times the asynchronous packet is copied.

6. A communication device according to claim 1, further comprising:
a receiving unit which receives the encrypted added asynchronous packet transmitted from the transmitting unit;
a decryption unit which decrypts the encrypted added asynchronous packet received by the receiving unit and outputs the added asynchronous packet; and
an extraction unit which extracts real data, except for the data added by the padding unit, from the added asynchronous packet output from the decryption unit.

7. A communication device according to claim 6, wherein the extraction unit detects data length information on a length of the real data of the asynchronous packet and based on the detected data length information, extracts the real data except for the added data, from the added asynchronous packet output from the decryption unit.

8. A communication device according to claim 6, wherein the decryption unit detects key rewrite information which rewrites key information used for encryption by the encryption unit and, based on the latest key information rewritten by the key rewrite information, decrypts the encrypted added asynchronous. packet received by the receiving unit.

9. A communication device according to claim 6, further comprising:
a copy function which detects copy control information for limiting the number of times the asynchronous packet received by the receiving unit is copied and copies at least the asynchronous packet within the limit.

10. A communication device according to claim 6, wherein the receiving unit receives selected one of control information including the data length information on a length of the real data of the asynchronous packet, key rewrite information which rewrites key information used for encryption by the encryption unit and copy control information for limiting the number of times the asynchronous packet is copied.

11. A communication method comprising:
adding data to the asynchronous packet to form an integer multiple of a block length;
encrypting the added asynchronous packet and the synchronous packet; and
transmitting the encrypted added asynchronous packet and the encrypted synchronous packet.

12. A communication method according to claim 11, further comprising:
adding data length information on the length of the real data of the asynchronous packet to the encrypted added asynchronous packet.

13. A communication method according to claim 11, further comprising:
rewriting the key information used for encryption based on key rewrite information, and adding the key rewrite information to the encrypted added asynchronous packet.

14. A communication method according to claim 11, further comprising:
adding copy control information for limiting the number of times the asynchronous packet is copied, to the encrypted added asynchronous packet.

15. A communication method according to claim 11, further comprising:
inserting, between the encrypted added asynchronous packets, one of the control information including data length information on a length of real data of the asynchronous packet, key rewrite information which rewrites key information used for encryption, and the copy control information for limiting the number of times the asynchronous packet is copied.

16. A communication method according to claim 11, further comprising:
receiving the encrypted added asynchronous packet transmitted;
decrypting the encrypted added asynchronous packet and outputs the added asynchronous packet; and
extracting real data except for the added data from the added asynchronous packet.

17. A communication method according to claim 16, wherein data length information on a length of the real data of the asynchronous packet is detected and, based on the detected data length information, the real data except for the added data is extracted from the decrypted added asynchronous packet.

18. A communication method according to claim 16, further comprising:
detecting key rewrite information which rewrites key information used for encryption is detected, and based on the latest key information rewritten by the detected key rewrite information, the encrypted added asynchronous packet received is decrypted.

19. A communication method according to claim 16, further comprising:
detecting copy control information for limiting the number of times the asynchronous packet is copied, and copying at least the asynchronous packet within the limit.

20. A communication method according to claim 16, wherein one of the control information including the data length information on a length of the real data of the asynchronous packet, key rewrite information which rewrites key information used for encryption and copy control information for limiting the number of times the asynchronous packet is copied, is received as an exclusive control information packet.
